(19) United States
(12) Patent Application Publication
(10) Pub. No.: US 2007/0116946 A1
(43) Pub. Date: May 24, 2007

(54) Light Storage/Emitting Panels And Methods Of Making Same

(75) Inventors: Daniel Allen Rustin, Wayne, NJ (US); Julio Diaz, Irvington, NJ (US)

Correspondence Address: KAPLAN GILMAN GIBSON & DERNIER L.L.P., 900 ROUTE 9 NORTH, WOODBRIDGE, NJ, 07095, US

(73) Assignee: Acrilex, Inc., Jersey City, NJ (US)

(21) Appl. No.: 11/562,012

(22) Filed: Nov. 21, 2006

Related U.S. Application Data
(60) Provisional application No. 60/739,199, filed on Nov. 23, 2005.

(51) Int. Cl. C09K 11/00

(52) U.S. Cl. 428/332; 252/301.16; 252/301.35; 428/690

(57) ABSTRACT

Light storage and emitting devices are provided having a matrix and light storage and emitting material combined therewith. Methods of making light storage and emitting devices are provided.

### CROSS REFERENCE TO RELATED APPLICATIONS

This application claims the benefit of U.S. provisional Patent Application No. 60/739,199 filed Nov. 23, 2005, the entirety of which is incorporated herein by reference.

### FIELD OF THE INVENTION

The present invention relates to the field of light storage and emitting devices and in particular to devices adapted to collect light energy from existing light sources, store the energy within a matrix, and re-emit the light energy as visible light, and methods of making such devices.

### BACKGROUND

Emergency, or backup, lighting is required in most nonresidential buildings and at a minimum is highly desirable in those buildings and private residences. However, existing backup lighting typically uses battery backup or emergency generators as the power supply. Thus, existing emergency lighting is subject to failure. This drawback is compounded by the fact that a failure of such systems is often undetected until the need for the emergency lighting system arises, at which point it is too late to repair. Such systems therefore require regular inspection and replacement of batteries, sensors, electrical connections, lighting elements and the like.

It is common practice for owners of buildings, including office buildings, business establishments and residences, to leave lights on to deter theft. Such practice, while generally effective, is expensive and is subject to failure when a light fixture unexpectedly burns out or the power supply is cut off.

Photoluminescent technology currently in use for denoting exits is inadequate to meet the requirements for useful backup lighting. Signs using photoluminescence typically require a minimum of five foot-candles (approximately 54 lux) of external light on the sign face at all times in order to be seen.

Therefore there is a need for backup, emergency and safety lighting that is not subject to failure. Further, there is a need for a cost-effective and efficient alternative to “leaving the lights on”.

### SUMMARY OF THE INVENTION

Devices in accordance with the present invention provide visible light immediately after standard lighting sources are doused. Devices in accordance with the present invention are not prone to malfunction or improper charge, as the standard light source supplies all the energy required during normal operation.

In one aspect devices are provided that collect light energy from light sources, store the light energy within a matrix such as acrylic, and re-emits the light energy as visible light for the purpose of illumination, pathway marking, and way guidance in black out conditions, or when power to light sources is interrupted. In one aspect, “glow in the dark” devices are provided in the form of for example a lighting panel.

In another aspect devices according to the present invention can be adapted for use as a backup light source, and a fail safe device, in the event existing powered backup emergency light sources fail to function. In another aspect devices according to the present invention are adapted to operate as a safety device in cases where people are suddenly left in areas, in which, inadvertently or deliberately, lights have been turned out, in which case backup systems will not be activated.

Devices in accordance with the present invention can be employed to provide lighting to unoccupied areas and/or buildings for theft deterrence and general safety, without any concern for power failure and without expense.

Methods for making the devices disclosed are provided comprising providing a suitable material such as but not limited to acrylic and incorporating therein light storage/emitting material.

These and other aspects of the invention will be apparent to those skilled in the art.

### BRIEF DESCRIPTION OF THE FIGURES

FIG. 1 depicts a device in accordance with an embodiment of the present invention.

FIG. 2A depicts a device in accordance with an embodiment of the present invention.

FIG. 2B depicts a device in accordance with an embodiment of the present invention.

FIG. 3 is a graphical representation of afterglow of devices in accordance with embodiments of the present invention.

FIG. 4 is a table containing values for afterglow of devices in accordance with embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment.

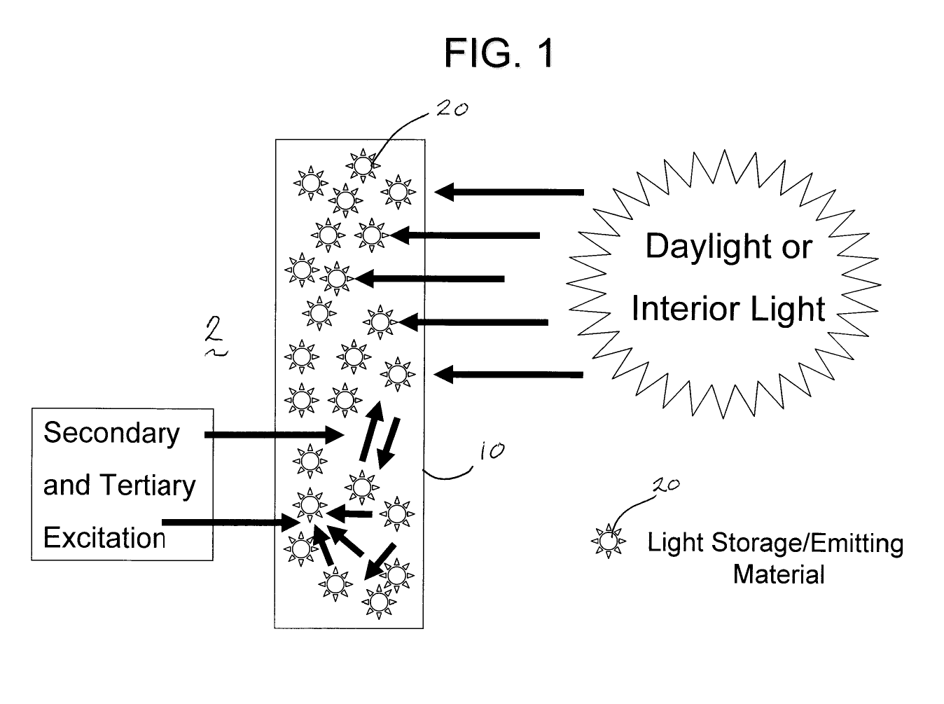

Now referring to FIG. 1, in an embodiment, a device 2 in accordance with the present invention comprises a matrix 10 and light storage/emitting material 20.

Matrix 10 may be composed of any suitable material that can be formed into a sheet and accommodate the inclusion of light storage/emitting material 20, such as but not limited to acrylic, clear polymer and semi-clear polymers forming a base composition of preferably plastic construction. More specifically, acceptable materials for matrix 10 include but are not limited to acrylic, polycarbonate, PETG, PVC, styrene, CAB, and SAN. Preferably, matrix 10 comprises clear acrylic, clear polycarbonate, PETG, clear PVC, clear styrene, clear CAB, or clear SAN. In a most preferred embodiment matrix 10 comprises clear acrylic.

In cases where matrix 10 is composed of an acrylic, materials such as but not limited to clear cell cast PMMA (polymethylmethacrylate) are acceptable.

Light storage/emitting material 20 (commonly referred to as “photoluminescent” or “phosphorescent” material) may include but is not limited to europium-doped magnesium strontium silicate crystalline pigment, strontium aluminate, zinc sulphide pigment, or any combination of the foregoing. The concentration of light storage/emitting material 20 in the matrix 10 is preferably between about 1% to about 20% by weight. Crystals of magnesium strontium silicate are commercially available from manufacturers such as USR Optonix. Strontium aluminate, manufactured by Nemoto is sold under the brand name Luminova, and available from Honeywell under the brand name Lumilux.

In a preferred embodiment matrix 10 is a solid rigid plastic flat or shaped sheet which contains light/storage emitting material 20 in the form of photoluminescent crystals, resulting in a device 2 which will glow in the dark, or emit light it has received during its charging period. In other embodiments a UV brightener/stabilizer such as UVITEX™ OB, a fluorescent whitening agent, manufactured by Ciba Specialty Chemicals, may be included during the polymerization phase of production to insure a “white” appearance of the finished product when illuminated by secondary light source. This may be necessary to provide correct color during regular use.

FIG. 1 illustrates the charging of a device 2 as a result of light exposure and emittance of light from material 20.

In one embodiment, light storage/emitting material 20 is present in the matrix 10 in a dosage of about 4% by weight of composition where the matrix 10 is acrylic. In one example, matrix 10 is an acrylic sheet containing a concentration of 4% light storage/emitting material 20 crystals in the acrylic sheet for a lighting application. In this embodiment, at this dosage level, the overall appearance of the lighting panel as it is illuminated from behind by fluorescent light bulbs is white. This is useful for a desirable appearance of the matrix 10 as an acrylic sheet in its normal use as a light panel fixture covering fluorescent lighting while power is on.

In other embodiments formulations based on up to 20% by weight concentrations of the light/storage emitting material 20 may be employed for additional brightness, duration of “after glow”, and decorative effects. In these embodiment, at these higher dosages, the normal appearance of the matrix 10 when illuminated is not necessarily white.

Upon terminating exposure of a device 2 in accordance with the present invention to a light source (which may be artificial or natural), the device 2 retains an afterglow. Afterglow colors may be provided by inclusion of appropriate pigments in the matrix 10. Many colors are possible, such as but not limited to blue, blue-green, red, pink, orange, red-orange, yellow, and white.

In an embodiment, additives such as but not limited to pigments, dyes, “sparkling” elements, iridescent elements and the like may be added to the formulation for ornamental effect. The additives may be added to provide patterns in the matrix 10, such as but not limited to faux marble patterns.

The devices 2 in accordance with the invention can be provided with varying degrees of translucency. In some embodiments, device 2 can be provided with matte or textured surfaces to enhance the three dimensional appeal of the device 2.

When device 2 is in the form of a sheet, sheets may be provided in a variety of dimensions and shapes, with preferred thickness of sheets ranging from about 1/32 inch to about 2 inches, most preferably from about 1/8 inch to about 3/8 inch.

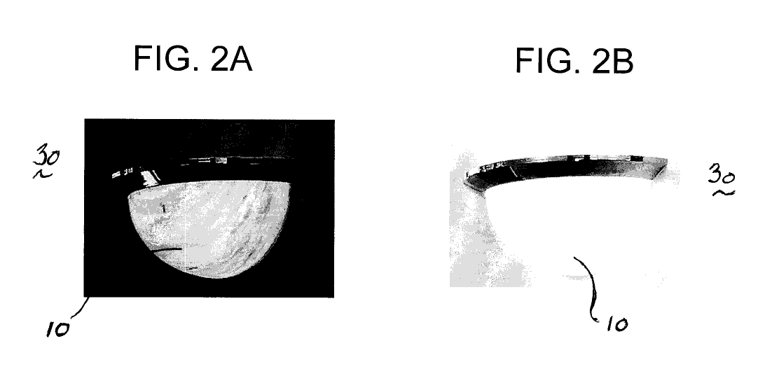

Now referring to FIGS. 2A and 2B, in another embodiment, a non-drop ceiling light application is depicted. When power is supplied to the light fixture 30 (“Power On” in FIG. 2B), the lighting source (such as a normal light bulb in the fixture, not shown) provides normal luminescence through matrix 10. When power is not supplied to the light source (“Power Off” in FIG. 2B), the matrix 10 provides luminescence as a result of the light storage/emitting material 20 having been excited by the light source (not shown). As will be apparent to a skilled artisan, the present invention may be employed in applications such as but not limited to indoor and outdoor light fixtures, lenses for wall and ceiling panels, pathway sign and marking systems and the like, floor lighting applications such as but not limited to walkways in theaters, airplanes and the like, uses in instrument panels in automobiles, aircraft, boats and the like as well as in decorative lighting applications which may include other colors for ornamentation purposes.

In accordance with the present invention, devices are provided that provide illumination without backup power sources during a power outage and extend the period of illumination once battery backup fails. The glow emitted from a fixture employing the present teachings lasts for hours. Unlike battery backup, or emergency generators, the illumination provided by devices according to the present invention is guaranteed to be there the instant the lights go out; there is no possibility of malfunction or improper charge, as preferably standard light sources can supply all the energy required during normal operation. The devices in accordance with the present invention can be charged and discharged indefinitely without any degradation to the performance of the product.

In accordance with one embodiment a method is provided comprising providing a matrix material and incorporating therein a light storage/emitting material. In one embodiment the method includes providing an acrylic material, adding a light storage/emitting material and optionally pigment and forming the combined elements into a flat or shaped sheet.

Sheets in accordance with the present invention may be produced in one embodiment by combining clear resin (or monomer) with photoluminescent crystals and utilizing a casting process or extrusion process to produce plastic sheets. In a preferred embodiment, devices in accordance with the present invention are produced by suspending photoluminescent crystals in uniform distribution, within a clear polymer matrix. Preferably the crystals are an integral part of the matrix material and are not bonded via a lamination or coating process. Preferably, photoluminescent crystals are encapsulated and suspended in a matrix of clear polymer. This allows light to travel to the spaces between crystals. Subsequently, the crystals are free to emit light in all directions. Crystals are preferably dispersed so as to be charged by a given light source at all depth levels of the matrix and emit light from all levels of the matrix, providing secondary and tertiary excitation, as shown in FIG. 1.

The following examples describe methods of making devices in accordance with the present invention.

### EXAMPLES

Casting

To make acrylic sheets containing photoluminescent crystals a pre- thickened, or viscous clear methylmethacrylate syrup is weighed according to the desired specifications of the batch being produced. Photoluminescent crystals are preferably weighed in separate containers, according to the percentage required for the product being produced, as well as any UV brightener or coloring additives. All ingredients are then blended together in a mixing tank until a homogeneous mixture is achieved. The mixture is then dispensed from the tank into containers which are to be used for filling preassembled molds for producing cast sheets of material. Into the containers, just prior to mold filling, initiators such as but not limited to VASO™ 52 initiator commercially available from DuPont, or TRIGONOX™ C initiator commercially available from Akzo Nobel, are added to begin the chemical reaction required for converting the monomer syrup into a polymerized acrylic sheet. The reaction is conducted under conditions of heat, such as a heated water bath maintained at approximately 120° F., to begin the chemical reaction and to maintain the temperature of the mixture during polymerization. It will be recognized by those having skill in the art that other commonly known methods for heating and controlling the curing process in acrylic casting may be employed, including but not limited to autoclaves, steam, or circulating heated water or oil piping. Maintaining a uniform temperature throughout the curing process is important. It will also be apparent to those skilled in the art the appropriate time and temperature for conducting the curing step, depending on the specific materials used and the equipment setup.

Following the initial curing of the sheets, a post curing operation is conducted to further harden and release residual monomer through the use of dry curing ovens at a range of 200-250° F., and for a period of time appropriate to the thickness of the sheets within the molds. Again, it will be apparent to the skilled artisan cell casting what is the appropriate length of time for this step.

Extrusion

In the use of extruded plastics, the photoluminescent pigment is blended with the monomer and polymerized into strands which are chopped into pellets. These pellets are then melted in an extruder and pushed or ejected though an extrusion die, to calender rollers which determine the thickness and size of the sheets being produced. As will be apparent to the artisan skilled in extrusion, the particular conditions such as temperature and time to be employed are dependent on the materials used and the equipment setup.

Injection molders melt the polymerized pellets as described above, and inject the molten mixture into dies which are made to shape individual finished parts, utilizing heat and pressure.

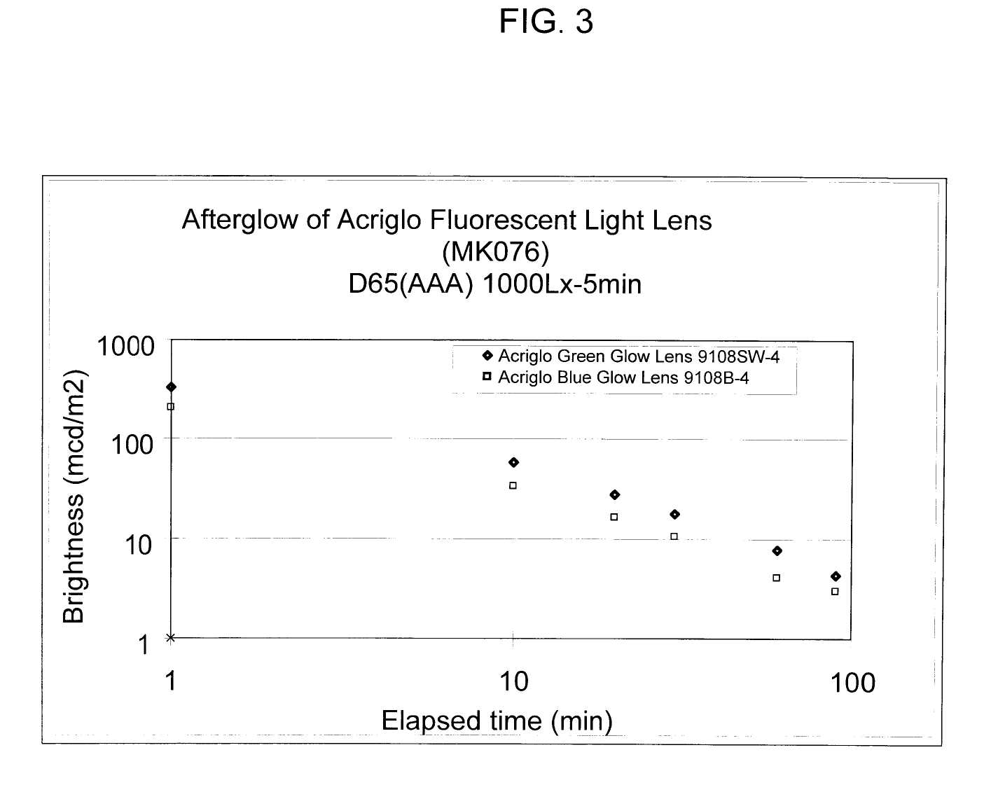

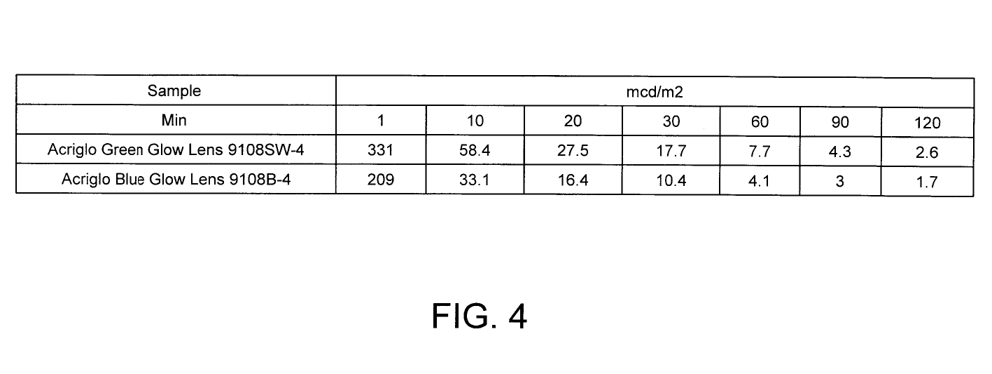

Now referring to FIG. 3 a graph is provided that depicts afterglow decay rate in devices in accordance with the present invention. Devices adapted as fluorescent light lenses consisting of 96% clear polymer with 4% photoluminescent crystals described as folows were tested. Green glow lenses comprising 96% clear polymer, and 4% SW300M Luminova phosphorescent pigment from Nemoto Corp, Japan. Blue glow lenses comprising 96% clear polymer, and 4% P170 Blue phosphorescent blue from USR Optonix Corp, Hackettstown, N.J. FIG. contains tabular data contained in FIG. 3.

While the preferred embodiments have been described and illustrated it will be understood that changes in details and obvious undisclosed variations might be made without departing from the spirit and principle of the invention and therefore the scope of the invention is not to be construed as limited to the preferred embodiment.

What is claimed is:

1. A device comprising a matrix comprising light storage/emitting material.

2. A device according to claim 1 the matrix comprising a plastic material.

3. A device according to claim 1 the matrix comprising material selected from the group consisting of acrylic, polycarbonate, PETG, PVC, styrene, CAB, and SAN.

4. A device according to claim 1 the matrix comprising clear acrylic.

5. A device according to claim 1 the light storage/emitting material comprising at least one photoluminescent crystal material.

6. A device according to claim 5 the light storage/emitting material comprising at least one photoluminescent crystal material selected from the group consisting of europium-doped magnesium strontium silicate crystalline pigment, strontium aluminate, zinc sulphide pigment, and combinations thereof.

7. A device according to claim 1 wherein the concentration of light storage/emitting material in the matrix is between about 1% to about 20%.

8. A device according to claim 1 wherein the concentration of light storage/emitting material in the matrix is between about 1% to about 10%.

9. A device according to claim 1 wherein the concentration of light storage/emitting material in the matrix is about 4%.

10. A device according to claim 1 further comprising a UV brightener/stabilizer.

11. A device according to claim 1 the matrix comprising a sheet having a thickness of between 1/32 and 2 inches.

12. A device according to claim 1 the matrix comprising a sheet having a thickness of between ⅛ and ⅜ inch.

13. A method of making a light emitting/storage device comprising providing a matrix selected from the group consisting of acrylic, polycarbonate, PETG, PVC, styrene, CAB, and SAN and incorporating in the matrix at least one light storage/emitting material selected from the group consisting of europium-doped magnesium strontium silicate crystalline pigment, strontium aluminate, zinc sulphide pigment, and combinations thereof.

14. The method according to claim 13 further comprising forming the matrix into a sheet.

15. The method according to claim 14 using a casting process to form the sheet.

16. The method according to claim 14 using an extrusion process to form the sheet.

17. The method according to claim 13 comprising suspending photoluminescent crystals in uniform distribution, within a clear polymer matrix.

18. The method according to claim 13 comprising encapsulating photoluminescent crystals and suspending the crystals in a matrix of clear polymer.

19. A device comprising a matrix formed in at least one sheet, the matrix comprising material selected from the group consisting of acrylic, polycarbonate, PETG, PVC, styrene, CAB, and SAN, the matrix further comprising light storage/emitting material comprising at least one photoluminescent crystal material selected from the group consisting of europium-doped magnesium strontium silicate crystalline pigment, strontium aluminate, zinc sulphide pigment, and combinations thereof in a concentration between about 1% to about 20%.
